(19) United States
(12) Patent Application Publication
(10) Pub. No.: US 2007/0211062 A1
(43) Pub. Date: Sep. 13, 2007

(54) Methods and systems for rendering complex text using glyph identifiers in a presentation data stream

(75) Inventors: Jeffery A. Engelman, Mead, CO (US); Reinhard H. Hohensee, Boulder, CO (US); Terry S. Luebbe, Mantorville, MN (US); Eric R. Mader, Captain Cook, HI (US); David E. Stone, Longmont, CO (US); John T. Varga, Longmont, CO (US)

Correspondence Address: DUFT BORNSEN & FISHMAN, LLP, 1526 SPRUCE STREET, SUITE 302, BOULDER, CO, 80302, US

(73) Assignee: International Business Machines Corporation

(21) Appl. No.: 11/374,261

(22) Filed: Mar. 13, 2006

(51) Int. Cl. G06T 11/00

(52) U.S. Cl. 345/467; 358/1.11

(57) ABSTRACT

Methods and systems for rendering code points on a presentation device with layout processing performed outside the presentation device. In one aspect, a layout processor translates one or more code points into a sequence of one or more glyph indices and corresponding positioning information. The glyph indices and corresponding positioning information may be included within a PTOCA control sequence. The glyph indices may be used by the presentation device to directly locate a corresponding glyph image in a font. The positioning information defines positioning of each glyph image so identified. Features and aspects hereof allow efficient layout of complex text in which glyph images and positioning may be dynamically determined in accordance with context or other attributes. The processing burden of such layout processing is removed from the presentation device without significantly increasing data transmission bandwidth between the presentation engine and external system utilizing the layout processor.

### RELATED PATENTS

This patent application is related to co-pending, commonly owned, patent application publication number US 2005/0200913 filed 11 Mar. 2004 and published 15 Sep. 2005.

### BACKGROUND

The invention relates to the field of rendering glyph images in a presentation system and more specifically relates to efficiently rendering complex text using glyph indices and positioning information.

Presentation systems include printing systems and other display technologies on which textual and graphical information from computing systems are presented to users. In general, textual information is presented as a sequence of glyphs representing textual characters. A glyph (often imprecisely referred to as a “character”) is a graphical representation of some textual information to be presented and may comprise one or more glyph images. A glyph image is a rasterized image of a particular character, or portion of a character, to be presented.

An application selects the particular glyphs to be presented and encodes the selected glyphs as index values typically referred to as code points. The code points represent indices into a currently selected font table that generally contains the glyph images (or may contain vector outline scalable descriptions of the glyph images to be rasterized in accordance with scaling parameters). In general, the glyph also has metric information associated with it indicative of size and spacing dimensions for relative placement of the glyph from the current position and a starting position for placement of a next glyph. With simple text data, there is a one-to-one relationship between the code point and the glyph to be rendered. Presentation systems such as printing systems perform a simple table look up of the code point (e.g., in a currently selected font table), based on its encoding information, to determine the glyph to render. Also, metric information stored with each glyph can be used to position the glyph relative to the current starting position and to simply calculate the position of the next one. The next starting position may be simply computed by adding/subtracting an incremental size in the direction of presentation (e.g., left to right, right to left, top to bottom, etc.).

However, with complex text data, this one-to-one relationship between code points and glyphs does not exist. A more complex analysis must be used to identify the glyph and its position on the text line. Complex text may comprise character strings to be presented that have one or more of the following properties:
Bi-directionality: the visual ordering of text switches from right-to-left and left-to-right (e.g., Arabic, Hebrew, Urdu)
Shaping: character shapes depend on their context (e.g., Arabic, Indic scripts)
Ligatures: mandatory special forms for which there is no code point (e.g., Arabic)
Positioning: horizontal and vertical adjustments (e.g., Thai)
Reordering: character positions depend on context (e.g., Indic scripts)
Split characters: character may be represented by two separately positioned glyphs, depending on context.

The Unicode Standard has evolved as a widely accepted standard for encoding characters for transmission to a presentation device (e.g., a printing system). The Unicode Standard is well known to those of ordinary skill in the art and is readily available as a plurality of related specifications at http://www.unicode.org. The Unicode Standard generally provides a consistent way of encoding text for a large percentage of the world's languages and scripts.

The Unicode Standard establishes an architecture that encodes characters and not the glyphs used to represent them. This distinction is difficult to appreciate in simple scripts, such as Latin, Cyrillic, and Greek, where characters are consistently represented by a single glyph. However, with many of the scripts encoded by Unicode, the glyph and position used for a character are variable. As the use of the Unicode Standard for encoding text becomes increasingly widespread, it is a growing problem to efficiently render such complex text.

Processing complex text is highly script and language dependent and requires the use of a layout engine to analyze the text and generate the proper glyph identifiers (IDs) and glyph positions for rendering. An exemplary layout engine has been developed by IBM as part of the International Components for Unicode (ICU). Another layout engine, called Uniscribe, is used on Windows platforms.

A layout engine can reside within the printer or other presentation device as presently practiced in the art. In such a situation, the presentation data stream contains Unicode code points which are analyzed when received. Since the text analysis and layout is very compute intensive when compared to traditional text layout, this solution can greatly reduce the throughput that can be achieved by the printer or other presentation device. For example, in the case of high-volume production printers using continuous form stock, the additional processing time can be prohibitive. If the time to layout and render an image for a page containing complex text is large it could exceed the brief window in which a next page image must be prepared to be forwarded to the marking engine.

Conversely, a layout engine could reside on a print server computing platform and be invoked by an application through a print driver. Typically such drivers will rasterize the glyphs and send them to the printer (or other presentation device) as raster bit maps. Alternatively, such drivers may create an image of the entire page and send this to the printer. In both cases, the data stream generated is much larger than one where the text is represented by code points. In a networked environment, significantly more bandwidth is consumed which can impact the network performance. Also, many printers require more time to render a page image compared to a page of text data due to the increased data transfer bandwidth utilization. Thus a page containing mere text (even though it may be complex text) is more easily rendered by many printers (or other presentation devices) as compared to a full page raster image.

It therefore remains an ongoing problem to efficiently process complex text in many presentation systems including, for example, printing systems.

### SUMMARY

The invention solves the above and other related problems with methods and associated systems and apparatus for efficiently rendering complex text in a presentation device by providing glyph indices and corresponding positioning information from an external layout processor.

In one aspect a method is provided for rendering glyphs on a presentation device. The method includes formatting a code point identifying one or more glyphs to form a presentation including one or more glyph indices and including positioning information for the one or more glyph indices. The formatting is performed external to the presentation device. The method also includes forwarding the presentation to a presentation device. A controller of the presentation device may then present the presentation. The step of presenting includes retrieving one or more glyph images from a font using the one or more glyph indices and rendering the one or more glyph images at positions determined in accordance with the positioning information.

In another aspect a presentation system is provided. The presentation system includes a presentation device adapted to present received information to a user. The system also includes an application adapted to generate one or more code points comprising a portion of a presentation. In addition the system includes a layout processor communicatively coupled to receive the one or more code points and adapted to translate the one or more code points into one or more glyph indices and corresponding positioning information. The system is adapted to forward the returned one or more glyph indices and corresponding positioning information to the presentation device for presentation to a user.

The invention may include other exemplary embodiments described below.

### BRIEF DESCRIPTON OF THE DRAWINGS

The same reference number represents the same element on all drawings.

FIGS. 1 through 4 are block diagrams of exemplary embodiments of systems in accordance with features and aspects hereof to translate code points into one or more glyph indices and corresponding positioning information that is provided to the presentation device.

FIGS. 5 and 6 are flowcharts describing exemplary methods in accordance with features and aspects hereof to translate code points into one or more glyph indices and corresponding positioning information that is provided to the presentation device.

### DETAILED DESCRIPTION OF THE DRAWINGS

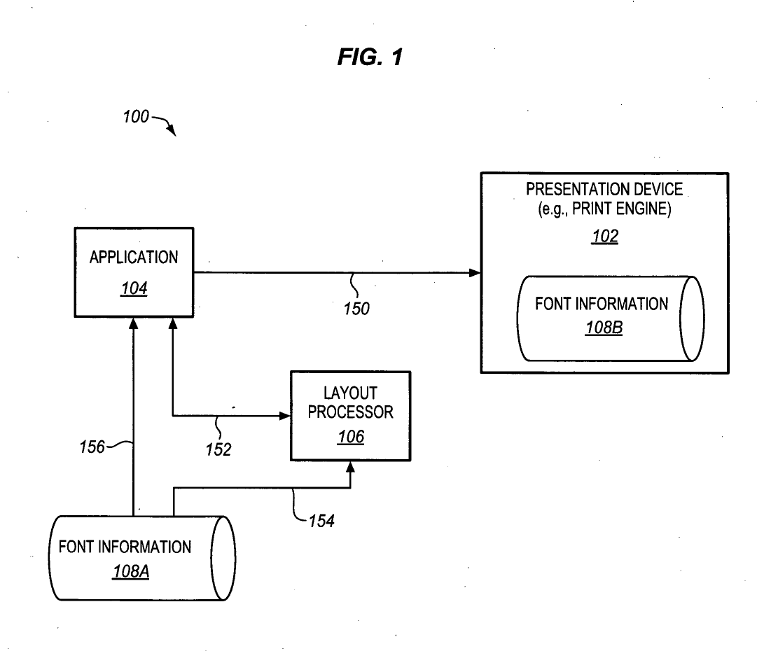

FIGS. 1 through 6 and the following description depict specific exemplary embodiments of the present invention to teach those skilled in the art how to make and use the invention. For the purpose of this teaching, some conventional aspects of the invention have been simplified or omitted. Those skilled in the art will appreciate variations from these embodiments that fall within the scope of the present invention. Those skilled in the art will appreciate that the features described below can be combined in various ways to form multiple variations of the present invention. As a result, the invention is not limited to the specific embodiments described below, but only by the claims and their equivalents.

FIG. 1 is a block diagram of a system 100 embodying features and aspects hereof to enhance performance of the presentation of complex text. Presentation device 102 may be, for example, a printing system or print engine incorporating a printer controller for generating textual and graphical images on printable medium. In addition, presentation device 102 may include other forms of presentation devices such as display screens and monitors. Application 104 represents any data processing application that generates textual information (and/or graphical information) to be presented to a user on presentation device 102.

Textual information is typically represented in the presentation as a plurality of character or glyph images. As noted above, simple text is typically encoded such that a single code point corresponds to a single glyph image. Positioning information is associated with each glyph image. The positioning information typically defines the position of this glyph image relative to a current position and defines the incremental position for a next glyph image relative to this glyph image. The glyph image itself and the positioning of each glyph image with respect to the current position and with respect to a next glyph image is substantially static in simple text. Application 104 may access the glyph images as well as the corresponding positioning information for a particular selected font 108A via path 156. Where the code points represent simple text, application 104 may simply forward the code point information to the presentation device 102 via path 150. Presentation device 102 may access identical font information 108B (identical to that of font information 108A). Since both application 104 and presentation device 102 access identical font information 108A and 108B, respectively, system 100 may assure that simple text is consistently and accurately presented on presentation device 102 as intended by application 104.

However, as noted above, various types of complex text give rise to substantially more complex computations to determine the glyph images to be presented and the proper positioning information associated with sequences of glyphs represented by the complex text. For example, in some complex text a single code point may be graphically represented by a plurality of glyph images positioned so as to overlay one another. Thus the one-to-one relationship between code points and glyph images that may be present for simple text cannot be assured for such complex text. Or, for example, in some complex text the spacing of a glyph image, the glyph image per se, or other attributes of a glyph image may be altered based on the context of a particular glyph image relative to other glyph images in a sequence of code points. The complexity of determining which glyph images are to be presented, how they are positioned, and/or how they are altered for such complex text gives rise to substantial computational complexity typically performed within a layout processor 106.

As noted above, such layout processing associated with complex text has, in the past, been performed by a layout processor integrated within the presentation device 102 (in particular often integrated within the device controller of the presentation device such as the print controller of a printing system). Integration of this complex layout processing within a device controller of the presentation system can give rise to performance problems. For example, in the context of continuous form printing systems, it is critical that the device controller perform adequately to generate full page images including rendered glyph images on the presentation device 102 quickly enough to assure continuous operation of the continuous forms printing system. Where the presentation device controller is incapable of generating full page images (including complex text) quickly enough, a continuous form printing system may have to stop the continuous form printing engine and then restart when layout processing has completed for a particular next image to be rendered. Stopping and restarting continuous form printing systems is a costly operation measured in terms of productivity of the printing application.

In accordance with features and aspects hereof, layout processor 106 is removed from the presentation device 102 and communicatively coupled with application 104 and font information 108. Some prior techniques have suggested removal of such layout processing from the presentation device but do so by performing complete layout and rendering of page images and/or all glyph images such that information passed from the application 104 to the presentation device 102 via path 150 represents fully rendered (e.g., rasterized) glyph and/or presentation page information. As noted above, exchange of such fully rendered glyph data or page data generates a different performance bottleneck due to the increased volume of information exchanged over path 150.

By contrast, layout processor 106 of FIG. 1 in accordance with features and aspects hereof cooperates with application 104 to generate glyph indices and associated corresponding positioning information representative of the code points to be presented by the presentation device 102. A glyph index is a value that uniquely identifies a glyph image in font information 108A (e.g., in a font file). In general, application 104 interacts with layout processor 106 through communication path 152. Font information 108A is available to application 104 through path 156 and to layout processor 106 via path 154. Application 104 may forward code points to layout processor 106 via path 152. Layout processor 106, in the case of complex text represented by the received code points, identifies one or more glyph images to be associated with each received code point and determines the position information associated with each such glyph image. The identified glyphs are each identified by a corresponding glyph index value identifying a particular glyph image within font information 108A (e.g., within a currently selected font file). In addition, positioning information associated with each such glyph image may be determined from metric information within the font information 108A and from context associated with other code points in the sequence of received code points from application 104. Layout processor 106 may then return the glyph indices and corresponding positioning information to application 104 via path 152.

Application 104 may then communicate the returned glyph indices and corresponding positioning information via path 150 to presentation device 102. Presentation device 102 then uses identical font information 108B available to its controller to retrieve the glyph images identified by the received glyph indices and positions the retrieved glyph images on the presentation medium as indicated by the corresponding position information for each glyph index. Transmission of glyph indices and corresponding positioning information between application 104 and presentation device 102 enhances performance of system 100 in two respects. First, the processing overhead within presentation device 102 is reduced dramatically so that the device controller of presentation device 102 may more assuredly maintain adequate performance for applications such as continuous form printing. Further, the volume of data exchanged between application 104 and presentation device 102 via path 150 is reduced by comparison with prior solutions that perform all layout and rendering external to the presentation device 102 such that fully rendered glyph images and/or page images were forwarded over path 150. Such image data transmissions are voluminous by comparison with the transmission of glyph indices and corresponding positioning information in accordance with features and aspects hereof. Further, the glyph images or page images may be rendered at a first resolution but the rendered images may be transmitted to a marking engine of a different resolution in a large enterprise with multiple marking engines. Thus the rendered images (glyph images or page images) received at the marking engine may be reformatted (scaled up or down) to match the resolution of the marking engine. Scaling of such rendered image data may degrade the quality of the presented data relative to what was initially intended in the layout processing of the application or print server.

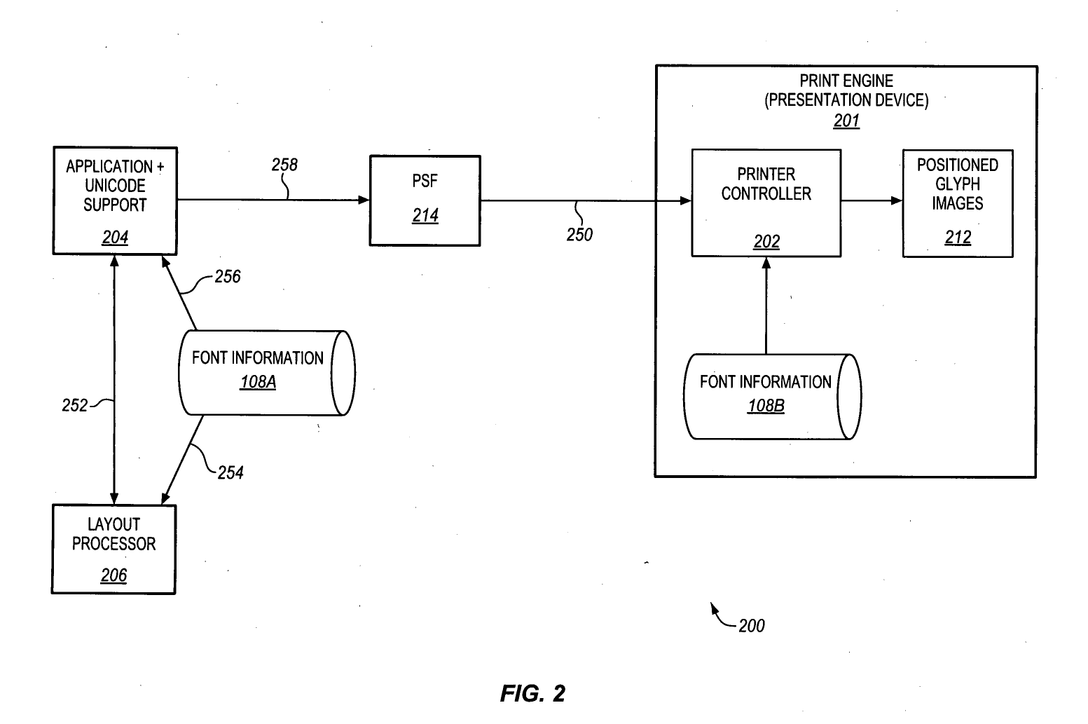

Those of ordinary skill in the art will readily recognize that system 100 of FIG. 1 is intended merely as suggestive of features and aspects hereof wherein a layout processor 106, external from the presentation device 102, aids in generating glyph indices and corresponding positional information for forwarding to the presentation device 102. Numerous particular embodiments will be readily apparent to those of ordinary skill in the art. In particular, FIGS. 2, 3, and 4 represent three exemplary embodiments wherein a layout processor, external from the presentation device, enhances performance of the overall system by reducing processing overhead within a controller of the presentation device while also reducing communication bandwidth utilization overhead associated with transferring fully rendered glyph images and/or page images.

FIG. 2 is a block diagram of an exemplary presentation system 200 embodying features and aspects hereof to improve performance in the context of a printing system. Print engine 201 (a presentation device) may include print controller 202 for rendering page images including glyph images 212 representative of simple and/or complex text to be presented to a user. Printer controller 202 receives text data, graphic image data, and control sequences through Print Services Facility 214 (“PSF”) via path 250. As generally known in the art, PSF 214 may be a print server computing node (e.g., network appliance) in a distributed, network oriented computing environment. In general, the function of a print server (e.g., PSF 214) is to buffer or spool completed print jobs and to manage prioritized queuing of those completed print jobs. Thus, PSF 214 generally transmits completed print jobs received from one or more applications 204 via path 258 to the print controller 202 of print engine 201 via path 250. Application 204 may include Unicode support for encoding and decoding of code points to be presented ultimately on print engine 201. Unicode code point information may be forwarded to layout processor 206 via path 252 to be translated into corresponding glyph indices and corresponding positioning information. Layout processor 206 may retrieve glyph indices and corresponding positioning information from font information 108A. Code point information received by layout processor 206 from the application 204 may then be translated into one or more glyph indices with corresponding positioning information associated with each of the one or more glyph indices.

The sequence of one or more glyph indices so generated by layout processor 206 may then be returned to application 204 via path 252. Application 204, in receipt of the returned one or more glyph indices and corresponding positioning information, may then forward the returned information via path 258 through PSF 214 and ultimately on to print engine 201 via path 250 and print controller 202. Layout processor 206 and application 204 share access to font information 108A via paths 254 and 256, respectively. System 200 of FIG. 2 therefore removes the processing burden of layout processing from print engine 201 (in particular removes the burden from print controller 202). System 200 of FIG. 2 also reduces the volume of data transferred over path 250 as compared to prior techniques that transmitted fully rendered glyph images and/or page images to a print engine.

Print controller 202 of print engine 201 and application 204 all share identical font information 108A and 108B. A glyph index serves to uniquely identify a glyph image in the font information (108A and 108B). The same glyph image and associated positioning information is therefore accessible to application 204, to layout processor 206, and to print controller 202. However, application 204 and layout processor 206 all utilize computational capacity external from that of print engine 201 (i.e., external to print controller 202). To ensure identical glyph images and metric information are contained in font information 108A and 108B, the same font information must be available in both computing contexts. For example, the font information 108A and 108B may be duplicate copies of the same font file—one font file resident within the print engine 201 associated with print controller 202, and a second copy resident elsewhere and accessible by application 204 and/or with layout processor 206. In addition, font information 108A may be downloaded to print engine 201 to create font information 108B during initialization of print engine 201 or as needed when a particular font is selected and not previously downloaded. Further, font information 108B may be permanently resident in print engine 201 and a corresponding copy 108A may be uploaded or otherwise available to computational capacity associated with application 204 and/or layout processor 206.

In accordance with features and aspects hereof, layout processor 206 is externalized from print engine 201 and in particular external from print controller 202. Application 204, layout processor 206, and PSF 214 may all be functional elements operable within a single computing node or may be distributed over any number of computing nodes (all external from print engine 201) in accordance with well-known distributed computing paradigms. Such functional elements may be implemented as client/server functional elements in a distributed computing environment or may be tightly coupled within a single computing context.

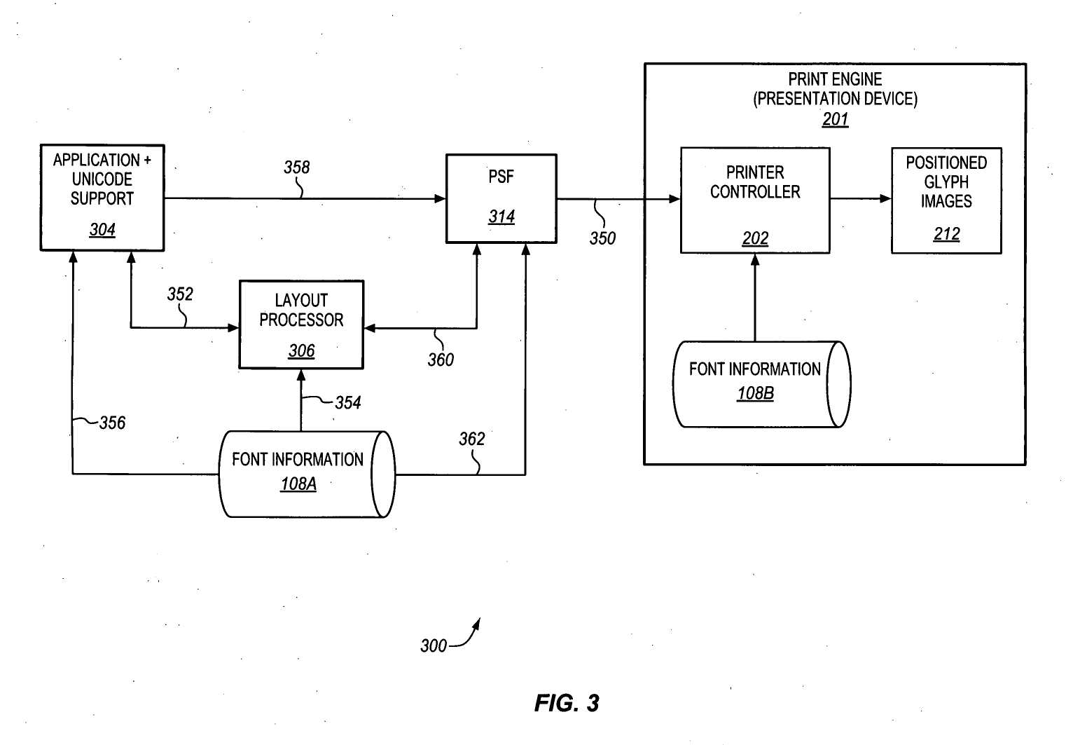

FIG. 3 is a block diagram depicting another variation of embodiments of features and aspects hereof. System 300 includes print engine 201 (e.g., a presentation device) identical to that of FIG. 2. In accordance with features and aspects hereof and as discussed above with respect to FIG. 2, print engine 201 and specifically printer controller 202 are devoid of processing overhead associated with layout processing for complex text. Rather, such complex text is converted to a control sequence comprising one or more glyph indices and corresponding positioning information. Each glyph index received by print engine 201 via path 350 uniquely identifies a corresponding glyph image in the font information 108B. Application 304, layout processor 306, and PSF 314 all share access to identical font information 108A (identical to font information 108B) via paths 356, 354, and 362, respectively. As compared to the exemplary embodiment of FIG. 2, system 300 of FIG. 3 performs translation from code points to glyph indices by cooperative processing in PSF 314 and layout processor 306. Application 304 forwards code point information via path 358 to PSF 314. PSF 314 forwards the sequence of complex text code points to layout processor 306 via path 360. Layout processor 306 may then translate the received code points into a sequence of glyph indices and corresponding positioning information for return to PSF 314. PSF 314 then transmits the returned glyph indices and corresponding positioning information to print engine 201 via path 350. As above, the transmission of glyph indices and positioning information to print engine 201 reduce computational complexity in printer engine 201 (i.e., in print controller 202) and also reduces the volume of data transmitted via path 350 to the print engine 201.

In addition, system 300 of FIG. 3 may interact with the print engine 201 to query as to the fonts that are known and available to the printer controller 202. PSF 314 may query print engine 201 to determine which fonts are known. Fonts that may be required but are not available may be downloaded from font information 108A accessed by PSF 314 to font information 108B in print engine 201 via print controller 202.

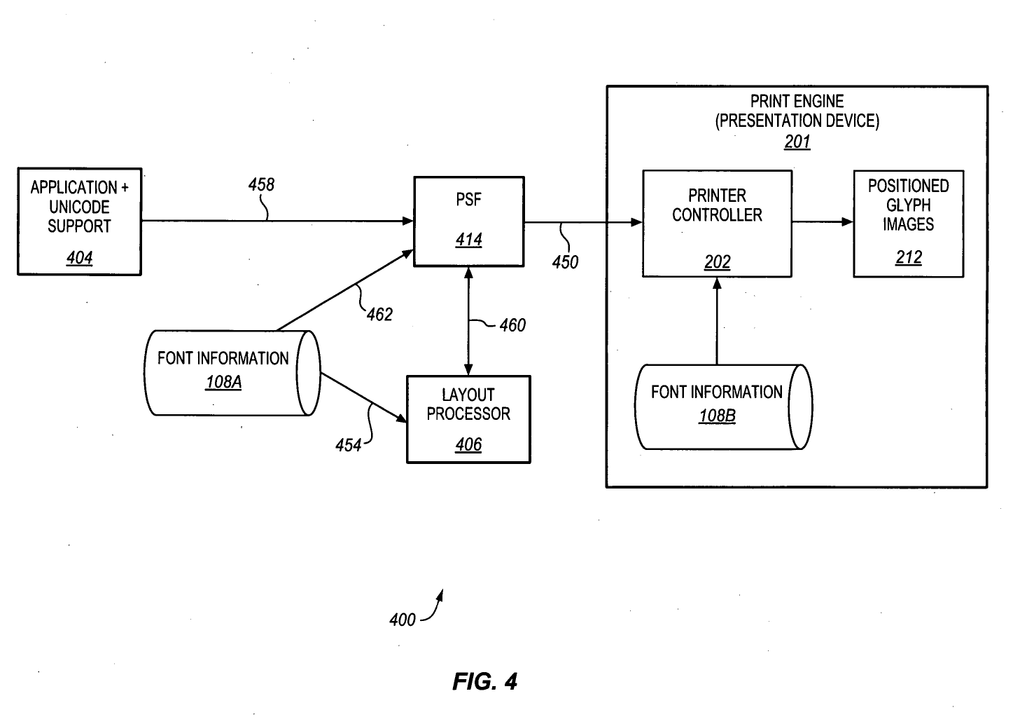

FIG. 4 is a block diagram showing yet another exemplary embodiment of a system 400 in accordance with features and aspects hereof. System 400 of FIG. 4 is similar to that of FIG. 3 except the application 404 has no interaction with the layout processor 406. Rather, code point information from application 404 is forwarded via path 458 to PSF 414 which, in turn, interacts with layout processor 406 to translate the code points into one or more glyph indices and corresponding positioning information. PSF 414 and layout processor 406 share access via paths 462 and 454, respectively, to font information 108A—a copy of font information 108B accessed within print engine 201.

Further, where print controller 202 does not support, for example, OpenType fonts in font information 108B, PSF 414 may prepare corresponding rasterized (e.g., rendered) glyph images from the OpenType font information 108A. The fully rendered glyph images may then be downloaded to the print controller 202 and saved by the print controller 202 as downloaded rasterized fonts in font information 108B.

In addition, where PSF 414 determines that print engine 201 is down-level (e.g., an older “legacy” printer) the glyph images accessed by PSF 414 from font information 108A may be sent to print controller 202 as image data to be placed on the rendered page. For example, in accordance with well known standards of IBM brand printing systems, such image data may be forwarded to print engine 201 as Image Object Content Architecture (“IOCA”) control sequences. As noted above, such image data transmission may degrade system performance but support for such a degraded mode operation may be provided by PSF 414 to permit support of both current printing systems as well as older, legacy printing systems.

System 400 of FIG. 4 therefore represents a configuration useful for supporting legacy printing systems devoid of some features to more efficiently support present day font information.

Those of ordinary skill in the art will readily recognize numerous equivalent structures in accordance with features and aspects hereof wherein processing burden associated with layout processing for complex text is removed from the limited computational capacity of a presentation device controller. Thus, computational complexity formerly within a presentation device controller is removed to external computational capacity. Further, the compact representation of characters as glyph indices with corresponding positioning information reduces the volume of data communicated to the presentation device as compared to prior solutions.

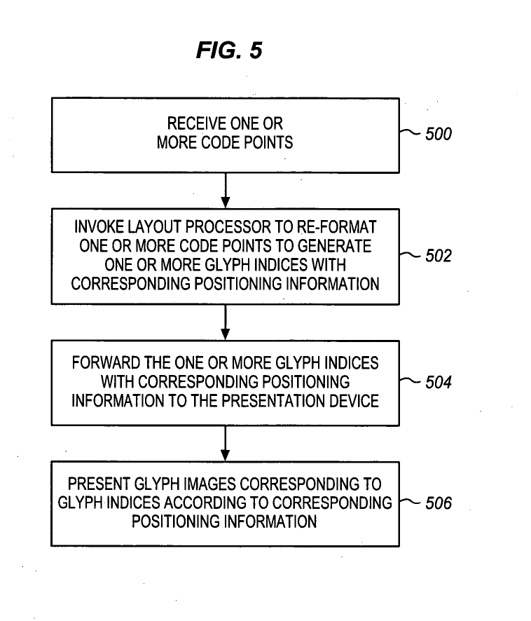

FIG. 5 is a flowchart describing a method in accordance with features and aspects hereof to perform layout processing external from a presentation device while reducing the volume of data exchange between the print and presentation device and external computational nodes generating the presentation. Elements 500 through 504 of FIG. 5 are performed by processing capacity external to the presentation device. Element 506 represents the simplified processing performed within a presentation device to present glyph images corresponding to received glyph indices all positioned in accordance with positioning information received with the glyph indices.

Element 500 is first operable within a system to receive one or more code points intended to represent complex text information in a presentation. Element 502 then invokes a layout processor (external from the presentation device) to reformat or translate the received one or more code points into one or more glyph indices with corresponding positioning information. As noted above, a code point in complex text may be represented as one or more glyph images. A glyph index is a compact representation pointing to a particular glyph image in a font information file. Preferably, an identical font information file is utilized by the presentation device and by the processing of elements 500 through 504 external to the presentation device. As noted above, such identical font information may be shared by downloading or uploading font information as a part of initialization of a presentation device or on an as needed basis as complex text is translated.

Element 504 is next operable to forward the reformatted or translated information to the presentation device. As noted above, representing complex text as the generated one or more glyph indices with corresponding positioning information is compact as compared to voluminous data required where, as in some prior solutions, an application and/or layout processor external to the presentation device renders all image data and forwards such rendered glyph images and/or page images to the presentation device. Thus the processing of elements 500 through 504 perform layout processing associated with complex text utilizing computational capacity external to the presentation devices and at the same time reduce the volume of data transmitted between the application and/or layout device and the presentation device as compared to prior solutions. Lastly, element 506 represents processing within the presentation device to fully render and present the identified glyph images identified by the glyph indices. The rendered glyph images are presented on the presentation medium (e.g., on a printed sheet of paper) at positions indicated by the corresponding positioning information that accompanied the received glyph indices.

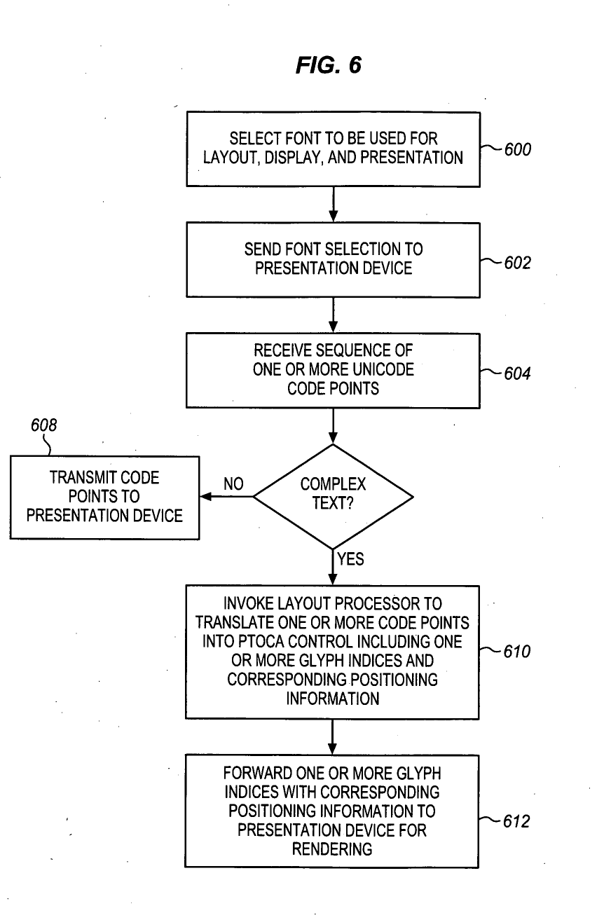

FIG. 6 is a flowchart describing in additional detail an exemplary method in accordance with features and aspects hereof. Processing of FIG. 6 represents all processing external to the presentation device to convert or translate one or more code points of complex text into one or more glyph indices with corresponding positioning information. Element 600 is first operable to select a font to be used for textual layout as well as any display and presentation. The selection of a font may be performed by generating and transmitting an appropriate control sequence to select a preexisting font for use in layout and presentation and/or to download an identified font to the presentation device. Element 602 then forwards the font selection control information to the presentation device. More generally, elements 600 and 602 represent any processing required to ensure that the application, layout processing, and presentation device all share common font information for any characters to be presented on the presentation device.

Element 604 is operable to a sequence of one or more code points. The sequence of one or more code points may be encoded, for example, as Unicode code points in accordance with well-known encoding techniques. The sequence of one or more code points is typically generated by an application creating a presentation for rendering by the presentation device. The generated Unicode code points are received by the layout processor for purposes of translating the code points into corresponding glyph indices if the code points represent complex text.

Element 606 next determines whether the code points represent complex text or simple text. As noted above, complex text is generally that text for which the glyph image and/or spacing to represent and position a particular identified character (identified by a code point) is dynamic based on the context of other code points of the sequence. As noted above, examples of dynamic aspects that may give rise to such complexity may include:
Bi-directionality: the visual ordering of text switches from right-to-left and left-to-right (e.g., Arabic, Hebrew, Urdu)
Shaping: character shapes depend on their context (e.g., Arabic, Indic scripts)
Ligatures: mandatory special forms for which there is no code point (e.g., Arabic)
Positioning: horizontal and vertical adjustments (e.g., Thai)
Reordering: character positions depend on context (e.g., Indic scripts)
Split characters: character may be represented by two separately positioned glyphs, depending on context.

Those of ordinary skill in the art will recognize numerous other factors associated with identifying complex text that requires significant computation for layout processing. The above list is therefore intended merely as exemplary of attributes of text that give rise to complex computations for layout of the presentation.

If element 606 determines that the received code points do not include any complex text, element 608 is then operable to simply transmit the received code points to the presentation device. Simple text may be easily rendered and positioned by processing capabilities within most presentation devices. Co-pending related patent application publication number US 2005/0200913 is informative of processing related to such text within a printing system. If element 606 determines that the received code points include aspects of complex text, processing continues with element 610 and 612. Element 610 invokes the layout processor (external from the presentation device) to translate the code points representing complex text into a sequence of glyph indices and corresponding positioning information. As noted above, each code point of complex text may be represented visually as one or more glyph images and hence may translate into one or more glyph indices. Each glyph index is an index value identifying a particular glyph image in the currently selected font information. The translation also includes positioning information corresponding to each identified glyph image. An exemplary encoding of a sequence of glyph indices and corresponding positioning information is discussed herein below.

Lastly, element 612 is operable to forward or transmit the encoded one or more glyph indices and corresponding positioning information to the presentation device for presentation to the user. The presentation device may receive the sequence of one or more glyph indices and corresponding positioning information, retrieve each identified glyph image from the currently selected font information, and render the retrieved glyph images at positions indicated by the corresponding positioning information.

In one embodiment, the code points may be Unicode code points within an Advanced Function Presentation (“AFP”) data stream. The layout process may therefore represent the sequence of one or more glyph indices and corresponding positioning information as a Presentation Text Object Content Architecture (PTOCA) control sequence. For example, the PTOCA control sequence may be a Glyph Run Marker (“GRM”) or a Text Glyph Run (“TGR”) as follows:

| Offset | Type | Name | Value Range | Meaning |
|---|---|---|---|---|
| 0 | CODE | PREFIX | X′2B′ | Control Seq. Prefix |
| 1 | CODE | CLASS | X′D3′ | Control Seq. Class |
| 2 | UBIN | LENGTH | 6 | Control Seq. Length |
| 3 | CODE | TYPE | X′6C′ | Control Seq. Function |
| | | | | Type |
| 4-5 | UBIN | GRLNGTH | 0-32767 | Length of Glyph |
| | | | | Information that |
| | | | | Follows this Control |
| 6 | CODE | GIDFMT | X′00′ | Size and Format of |
| | | | | Each Glyph ID Field |
| 7 | CODE | GPOSFMT | X′00′ | Size and Format of |
| | | | | Each Position Field |

Semantics: This exemplary PTOCA control sequence marks the start of a series of glyph identifiers and glyph positions. They identify glyphs from the active font and the position of each with respect to their glyph origin for the specified character rotation of the font. No data within the marked string of text is recognized as a PTOCA Control Sequence Prefix.

GRLNGTH specifies the total number of bytes in the series of alternating glyph identifiers (GID) and positions (GPOS) that follows the GRM. The bytes identified by this parameter are processed according to GIDFMT and GPOSFMT fields.

GIDFMT specifies the size and format of the glyph identifiers as follows:

X′00′ Each GID is 32 bits (4 bytes) long. The low-order 16 bits (bits 0-15) contain the glyph index. Bits 16-23 indicate the individual font file from the set of linked fonts. Bit 31 is set if the glyph represents a space character.

GPOSFMT specifies the size and format of the glyph positions as follows:

X′00′ Each GPOS is 32 bits (4 bytes) long. The low-order 16 bits (bits 0-15) contain the absolute value of the X-coordinate in Logical Units. The high-order 16 bits (bits 16-31) contain the absolute value of the Y-coordinate in logical units.

Pragmatics: The GRLNGTH parameter must specify a multiple of the size of a GID and GPOS element indicated by the GIDFMT and GPOSFMT parameters. For example, if the GIDFMT and GPOSFMT parameters are both set to X′00′, the GRLNGTH parameter must be a multiple of 8. If the GRLNGTH parameter is not a multiple of the GID and GPOS sizes, an exception condition exists. The standard action is to process the series up to the last complete GID-GPOS pair, skip the remaining bytes, and continue processing.

Those of ordinary skill in the art will recognize a wide variety of control sequences that may be specified within the PTOCA architecture and/or in accordance with other presentation device standards. The above PTOCA control sequence is therefore intended merely as exemplary of any such control sequence in which one or more glyph indices may be encoded along with corresponding positioning information for each encoded glyph index.

Although specific embodiments were described herein, the scope of the invention is not limited to those specific embodiments. The scope of the invention is defined by the following claims and any equivalents thereof.

We claim:

1. A method for rendering glyphs on a presentation device, the method comprising:
formatting, external to a presentation device controller, a code point identifying one or more glyphs to form a presentation including one or more glyph indices and including positioning information for the one or more glyph indices;
forwarding the presentation to a presentation device; and
presenting the presentation on the presentation device by operation of the presentation device controller wherein the step of presenting further comprises:
retrieving one or more glyph images from a font using the one or more glyph indices; and
rendering the one or more glyph images at positions determined in accordance with the positioning information.

2. The method of claim 1
wherein the step of formatting further comprises:
converting a sequence of one or more code points into a sequence of one or more glyph indices and associated positioning information associated with each glyph index.

3. The method of claim 2
wherein the step of converting further comprises:
converting a sequence of one or more Unicode code points into the sequence of one or more glyph indices and associated positioning information.

4. The method of claim 2
wherein the step of converting further comprises:
converting the sequence of one or more code points into a Presentation Text Object Content Architecture (“PTOCA”) data steam control that includes the sequence of one or more glyph indices and associated positioning information.

5. The method of claim 4
wherein the step of converting further comprises:
converting the sequence of one or more code points into a Glyph Run Marker (“GRM”) PTOCA control.

6. The method of claim 1
wherein the step of formatting further comprises:
converting a sequence of one or more complex text code points into a sequence of one or more glyph indices and associated positioning information wherein one or more code points of the sequence of code points represents complex text comprising text having one or more attributes selected from the group consisting of:
bidirectional text;
context based character shaping;
ligatures;
context based positioning;
context based re-ordering; and
context based character splitting.

7. The method of claim 1
wherein the step of formatting further comprises:
identifying complex text in a received sequence of code points;
invoking a layout processor to process the complex text to generate a corresponding sequence of one or more glyph indices and corresponding positioning information;
generating a control sequence including the one or more glyph indices and corresponding positioning information; and
forwarding the control sequence to the presentation device.

8. The method of claim 7
wherein the step of generating further comprises:
generating a PTOCA control including the one or more glyph indices and corresponding positioning information.

9. The method of claim 7 further comprising:
selecting a font wherein the selected font is used in conjunction with the layout processor to position each of the one or more glyph indices and wherein the selected font is used in conjunction with the presentation device to render the glyph images corresponding to the one or more glyph indices at positions indicated by the positioning information.

10. A presentation system comprising:
an application adapted to generate one or more code points comprising a portion of a presentation; and
a layout processor communicatively coupled to receive the one or more code points and adapted to translate the one or more code points into one or more glyph indices and corresponding positioning information,
wherein the system is adapted to forward the one or more glyph indices and corresponding positioning information to a presentation device for presentation to a user.

11. The presentation system of claim 10 further comprising:
a presentation device adapted to present received information to a user, the presentation information including one or more glyph indices and corresponding positioning information.

12. The presentation system of claim 10
wherein the layout processor is communicatively coupled to receive the one or more code points from the application and is communicatively coupled to return the one or more glyph indices and corresponding positioning information to the application, and
wherein the application is communicatively coupled to forward the returned one or more glyph indices and corresponding positioning information to the presentation device.

13. The presentation system of claim 10 further comprising:
a print services facility (“PSF”) communicatively coupled to the application and communicatively coupled to the presentation device and communicatively coupled to the layout processor,
wherein the PSF is adapted to receive the one or more code points from the application and is further adapted to forward the received one or more code points to the layout processor and is further adapted to receive the one or more glyph indices and corresponding positional information from the layout processor and is further adapted to forward the one or more glyph indices and corresponding positional information to the presentation device.

14. A method for rendering glyph images on a presentation device, the method comprising:
receiving, within a layout processor external to the presentation device, a plurality of code point values;
translating, within the layout processor, the received plurality of code points into one or more glyph indices and corresponding positioning information;
transmitting the one or more glyph indices and corresponding positioning information from the layout processor to the presentation device; and
rendering glyph images, within the presentation device, corresponding to the one or more glyph indices and in accordance with the positioning information.

15. The method of claim 14
wherein the step of receiving further comprises:
receiving a plurality of code points each code point comprising an encoded reference to a character wherein the encoding is selected from the group consisting of Unicode and OpenType.

16. The method of claim 14
wherein at least one code point of the plurality of code points represents complex text comprising text having one or more attributes selected from the group consisting of:
bidirectional text;
context based character shaping;
ligatures;
context based positioning;
context based re-ordering; and
context based character splitting.

17. The method of claim 14
wherein the layout processor is coupled to a print services facility (“PSF”) which is, in turn, coupled to the application,
wherein the step of receiving further comprises:
receiving, within the PSF, the plurality of code points from the application; and
forwarding the received plurality of code points from the PSF to the layout processor.

18. The method of claim 17
wherein the step of transmitting further comprises:
returning the one or more glyph indices and corresponding positioning information from the layout processor to the PSF; and
forwarding the returned one or more glyph indices and corresponding positioning information from the PSF to the presentation device.

19. The method of claim 14
wherein the step of translating further comprises:
translating the plurality of code points into a Presentation Text Object Content Architecture (“PTOCA”) control including the one or more glyph indices and the corresponding positioning information.
